(19) United States
(12) Patent Application Publication
(10) Pub. No.: US 2014/0380231 A1
(43) Pub. Date: Dec. 25, 2014

(54) SYSTEMS AND METHODS FOR PROTECTING A USER INTERFACE COMPONENT FROM ACCIDENTAL OPERATION

(71) Applicant: AppSense, Limited, Warrington (GB)

(72) Inventor: James TUPPER, Warrington (GB)

(21) Appl. No.: 13/926,290

(22) Filed: Jun. 25, 2013

(51) Int. Cl. G06F 3/0481; G06F 3/0484

(52) U.S. Cl. CPC G06F 3/0481; G06F 3/0484
USPC 715/781

(57) ABSTRACT

Systems and methods are provided for protecting a user interface component from accidental operation. A user interface component is displayed that cannot be operated that includes an area and is associated with an action that can be invoked when the user interface component can be operated. Data indicative of an interaction with the user interface component is received. A portion of the area of the user interface component is modified based on the user interaction. If the modified portion is greater than a predetermined threshold, the user interface component is activated such that the user interface component can be operated to invoke the associated action.

### TECHNICAL FIELD

Embodiments of the invention generally relate to protecting a user interface component from accidental operation, and in particular to requiring user input or other user investment before allowing a user to operate a user interface component.

### BACKGROUND

With the ever-increasing use of computer programs and websites to perform binding user transactions, many important or irreversible actions can be performed by a simple click of a button, check of a checkbox, selection of a menu item, or other user interface action. Such actions include sending an incomplete email, permanently deleting important files, paying for an item that a user was only considering, and accidentally transferring ownership of a resource. While it would be beneficial to be able to simply undo such actions, some of these operations are, by necessity, irrevocable. Therefore a user can often easily press the wrong button, regardless of the UI design.

Previous solutions to avoid accidental operation of user interface components often involve displaying a confirmation dialog when a user invokes the user interface component before allowing the user to proceed with the action. For example, if a user clicks a “purchase” button, the user may be presented with a box that asks the user “Do you wish to proceed with this purchase?,” and includes a “Yes” button that the user can click to proceed and a “No” button that the user can click to cancel the action. However, if the user doesn't read the message or reflexively clicks “Yes,” then the action will be carried out even if the user did not want to proceed (or didn't realize the consequences of clicking “Yes”).

### SUMMARY

In accordance with the disclosed subject matter, systems, methods, and non-transitory computer-readable media are provided for protecting a user interface component from accidental operation. Generally, buttons or other user interface components can be hidden behind an electronic scratch-card style cover, or presented in an inactive state (e.g., grayed out). The user interface component only becomes operable after sufficient action by the user. For example, the button is only revealed after a user scratches off a sufficient amount of the cover, or scratches off a sufficient amount of the inactive user interface component.

The disclosed subject matter includes a computerized method for protecting a user interface component from accidental operation. The method includes displaying, by a computing device, a user interface component that cannot be operated, wherein the user interface component comprises an area and the user interface component is associated with an action that can be invoked when the user interface component can be operated. The method includes receiving, by the computing device, data indicative of an interaction with the user interface component. The method includes modifying, by the computing device, a portion of the area of the user interface component based on the user interaction. The method includes determining, by the computing device, whether the modified portion is greater than a predetermined threshold. The method includes, if the modified portion is greater than the predetermined threshold, activating, by the computing device, the user interface component such that the user interface component can be operated to invoke the associated action.

The disclosed subject matter further includes a computing device including a database and a processor in communication with the database, and configured to run a module stored in memory that is configured to cause the processor to display a user interface component that cannot be operated, wherein the user interface component comprises an area and the user interface component is associated with an action that can be invoked when the user interface component can be operated. The module stored in memory is configured to cause the processor to receive data indicative of an interaction with the user interface component. The module stored in memory is configured to cause the processor to modify a portion of the area of the user interface component based on the user interaction. The module stored in memory is configured to cause the processor to determine whether the modified portion is greater than a predetermined threshold. The module stored in memory is configured to cause the processor to, if the modified portion is greater than the predetermined threshold, activate the user interface component such that the user interface component can be operated to invoke the associated action.

The disclosed subject matter further includes a non-transitory computer readable medium. The non-transitory computer readable medium has executable instructions operable to cause an apparatus to display a user interface component that cannot be operated, wherein the user interface component comprises an area and the user interface component is associated with an action that can be invoked when the user interface component can be operated. The instructions are operable to cause the apparatus to receive data indicative of an interaction with the user interface component. The instructions are operable to cause the apparatus to modify a portion of the area of the user interface component based on the user interaction. The instructions are operable to cause the apparatus to determine whether the modified portion is greater than a predetermined threshold. The instructions are operable to cause the apparatus to, if the modified portion is greater than the predetermined threshold, activate the user interface component such that the user interface component can be operated to invoke the associated action.

The techniques described herein can protect accidental invocation of a user interface component (e.g., a button press, a menu selection, etc.) such that dangerous operations require more investment from the user than trivial operations. The amount of investment can be configured for a desired application by requiring more work to be done depending on how dangerous the operation is, such as by having larger covers that must be “scratched away” to expose an active user interface component and/or to require more of the cover to be cleared before exposing the user interface component. The techniques described herein can allow dangerous user interface components to sit alongside less dangerous user interface components without the typical danger that a miss-press will result in undesired and often irreversible consequences. Additionally, if three dangerous user interface components (e.g., buttons) are in a row, the user must work to reveal a single button and then activate it, removing the risk of a single miss-press (or a reflexive “Ok” on the pop-up dialog or related workflow).

These and other capabilities of the disclosed subject matter will be more fully understood after a review of the following figures, detailed description, and claims. It is to be understood that the phraseology and terminology employed herein are for the purpose of description and should not be regarded as limiting.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 is an exemplary diagram of a system configured to protect a user interface component from accidental operation, according to some embodiments;

FIG. 2 is an exemplary diagram of a user interface with a user interface component protected by a cover to prevent accidental operation, according to some embodiments;

FIG. 3A is an exemplary diagram of a user interface with a portion of a cover to prevent accidental operation removed to expose a portion of the user interface component, according to some embodiments;

FIG. 3B is an exemplary diagram of a user interface with a portion of a cover to prevent accidental operation removed, according to some embodiments;

FIG. 4 is an exemplary diagram of a user interface component that is revealed after sufficient interaction with a cover, according to some embodiments; and

FIG. 5 is an exemplary diagram of a computerized method for protecting a user interface component from accidental operation, according to some embodiments.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid unnecessary complication of the disclosed subject matter. In addition, it will be understood that the embodiments provided below are exemplary, and that it is contemplated that there are other systems and methods that are within the scope of the disclosed subject matter.

The techniques described herein provide for protected user interface components that require a pre-configured amount of investment from the user (e.g., interaction with the component) before allowing the user to invoke the user interface component. Requiring the user investment helps to avoid or prevent a user from accidentally operating the user interface component. The user interface components can include, for example, buttons, checkboxes, menu items, lists, and/or other user interface components. While some of the examples described herein are described using a button and a protective cover, one of skill in the art can appreciate that any type of user interface component can be protected from accidental operation using the techniques described herein.

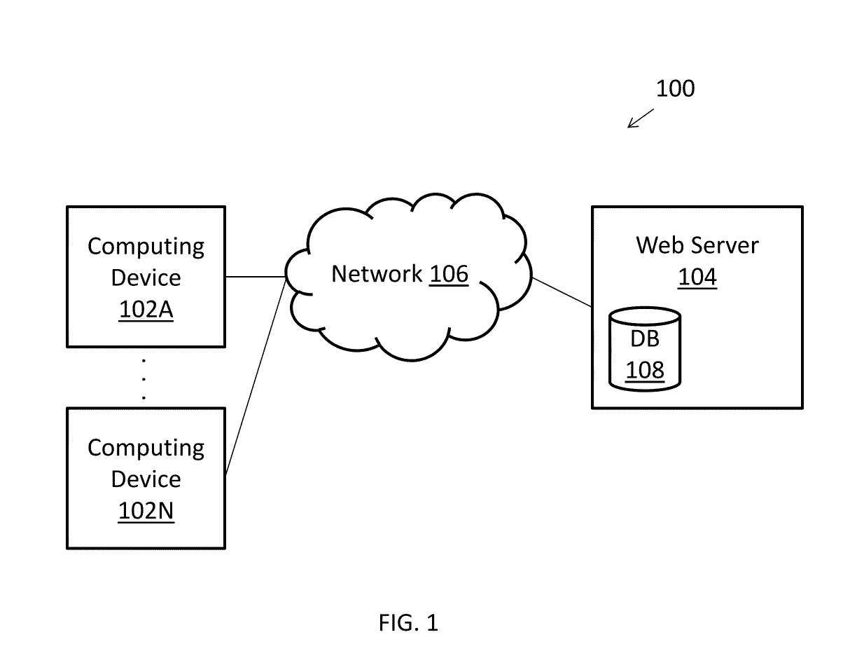

FIG. 1 is an exemplary diagram of a system 100 configured to protect a user interface component from accidental operation, according to some embodiments. The system 100 includes computer devices 102A through 102N, collectively referred to herein as computer devices 102. Computing devices 102 typically include a processor and memory (not shown). Computer devices 102 communicate with web server 104 via network 106. Web server 104 includes database 108. As is explained in further detail below, the web server 104 can be configured to provide websites or other online content to the computing devices 102 with one or more user interface components that are protected from accidental operation using the techniques described herein. While some examples described herein are described using a website or other remote content (e.g., phone applications), the techniques can be used in any type of application that uses user interface components (e.g., Microsoft Office, phone applications wholly resident on the computing devices 102, and/or other applications executed by the computing devices 102). In some examples, the techniques are implemented in a program installed on the computing devices 102 rather than provided remotely by web server 104, or are downloaded to the computing device 102 from the web server 104.

The communication network 106 can include a network or combination of networks that can accommodate public or private data communication. For example, the network 106 can include a local area network (LAN), a cellular network, a telephone network, a computer network, a packet switching network, a line switching network, a wide area network (WAN), any number of networks that can be referred to as an Intranet, and/or the Internet. Such networks may be implemented with any number of hardware and software components, transmission media and network protocols. FIG. 1 shows the network 106 as a single network; however, the network 106 can include multiple interconnected networks listed above.

The processors (e.g., in the computing device 102 and/or the web server 104) can be configured to implement the functionality described herein using computer executable instructions stored in a temporary and/or permanent non-transitory memory. The memory can be flash memory, a magnetic disk drive, an optical drive, a programmable read-only memory (PROM), a read-only memory (ROM), or any other memory or combination of memories. The processor can be a general purpose processor and/or can also be implemented using an application specific integrated circuit (ASIC), programmable logic array (PLA), field programmable gate array (FPGA), and/or any other integrated circuit. Similarly, database 108 may also be flash memory, a magnetic disk drive, an optical drive, a programmable read-only memory (PROM), a read-only memory (ROM), or any other memory or combination of memories. The web server 104 can execute an operating system that can be any operating system, including a typical operating system such as Windows, Windows XP, Windows 7, Windows 8, Windows Mobile, Windows Phone, Windows RT, Mac OS X, Linux, VXWorks, Android, Blackberry OS, iOS, Symbian, or other OSs. While not shown, the web server 104 can include a processor and/or memory in addition to the database 108.

The components of system 100 can include interfaces (not shown) that can allow the components to communicate with each other and/or other components, such as other devices on one or more networks, server devices on the same or different networks, or user devices either directly or via intermediate networks. The interfaces can be implemented in hardware to send and receive signals from a variety of mediums, such as optical, copper, and wireless, and in a number of different protocols some of which may be non-transient.

The software in the computing device 102 and/or web server 104 can be divided into a series of tasks that perform specific functions. These tasks can communicate with each other as desired to share control and data information throughout the computing device (e.g., via defined Application Programmer Interfaces (“APIs”)). A task can be a software process that performs a specific function related to system control or session processing. In some embodiments, three types of tasks can operate within the computing devices: critical tasks, controller tasks, and manager tasks. The critical tasks can control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem (as described below), and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem can be a software element that either performs a specific task or is a culmination of multiple other tasks. A single subsystem can include critical tasks, controller tasks, and manager tasks. Some of the subsystems that run on the computing device can include a system initiation task subsystem, a high availability task subsystem, a shared configuration task subsystem, and a resource management subsystem.

The system initiation task subsystem can be responsible for starting a set of initial tasks at system startup and providing individual tasks as needed. The high availability task subsystem can work in conjunction with the recovery control task subsystem to maintain the operational state of the computing device by monitoring the various software and hardware components of the computing device. Recovery control task subsystem can be responsible for executing a recovery action for failures that occur in the computing device and receives recovery actions from the high availability task subsystem. Processing tasks can be distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will preferably not be affected by that problem.

A shared configuration task subsystem can provide the computing device with an ability to set, retrieve, and receive notification of server configuration parameter changes and is responsible for storing configuration data for the applications running within the computing device. A resource management subsystem can be responsible for assigning resources (e.g., processor and memory capabilities) to tasks and for monitoring the task's use of the resources.

In some embodiments, the computing device can reside in a data center and form a node in a cloud computing infrastructure. The computing device can also provide services on demand such as Kerberos authentication, HTTP session establishment and other web services, and other services. A module hosting a client can be capable of migrating from one server to another server seamlessly, without causing program faults or system breakdown. A computing device in the cloud can be managed using a management system.

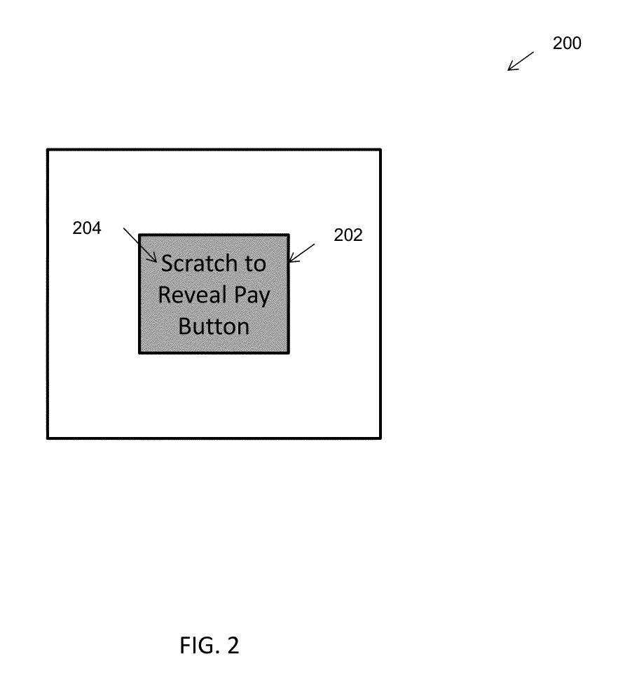

FIG. 2 is an exemplary diagram of a user interface 200 with a user interface component protected by a cover 202 to prevent accidental operation, according to some embodiments. The user interface 200 is displayed on the computing devices 102. For example, the user interface 200 can be a web page retrieved by a web browser executing on the computing device 102 from the web server 104. As another example, the user interface can be generated by a computer program executing on the computing devices 102 (e.g., by a local program executed on the computing device 102).

The cover 202 is representative of the location where the user interface component (not shown) resides in the user interface 200. The cover 202 includes a message 204 that states “Scratch to Reveal Pay Button.” The message 204 is intended to be illustrative only. For example, the message need not refer to the hidden user interface component (e.g., the pay button, for this example). As another example, the message can include instructions on how to reveal the hidden user interface component. For example, the message can include a set of one or more keystrokes or key press operations that can be entered to reveal the hidden user interface component (e.g., rather than scratching away the cover). The key press can be, for example, holding down multiple keys at once to reveal the button (e.g., pressing both the left and right arrows, typing shift three times in a row, etc.).

Conceptually, the cover 202 can be thought of as being displayed over a hidden user interface component such that the user interface component is not displayed since it is behind the cover. A user must electronically “scratch away” the cover to until the hidden user interface component is sufficiently revealed for the web server 104 to activate the user interface component. The computerized implementation can be configured to only draw or display the cover 202 (e.g., rather than graphically drawing the user interface component and then drawing the cover 202 over the interface component).

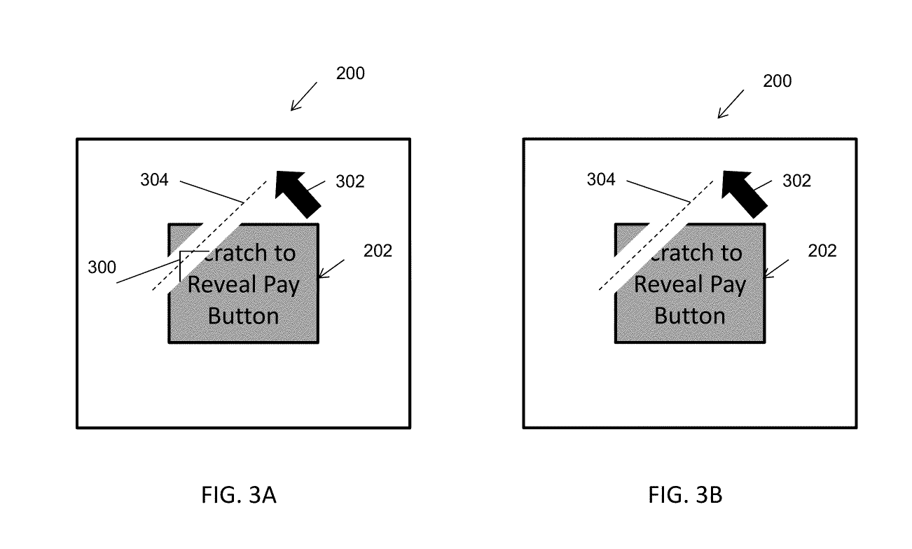

FIG. 3A is an exemplary diagram of the user interface 200 with a portion of the cover 202 to prevent accidental operation removed to expose a portion of the user interface component 300, according to some embodiments. The cursor 302 moves along the path represented by line 304 (which is not actually displayed on the user interface 200, but rather used for illustrative purposes). As the cursor 302 moves across the cover 202, the computing device (e.g., the web server 104 or the computing device 102) erases or removes the displayed portion of the cover 202 to reveal the hidden portion 300 of the user interface component that is below the removed portion.

Referring to the cursor 302, any type of input can be used to expose the hidden user interface component. For example, the input can be a mouse cursor (e.g., cursor 302), an input device on a touch pad (e.g., a stylus, a user's finger, etc.), and/or any other type of input to the computing device 102. In some embodiments, the cursor need only be moved over the cover 202 (e.g., without a mouse button being pressed during the movement). In some embodiments, a mouse button must be pressed while the cursor is moved over the cover.

One of skill in the art can appreciate that the path of the cursor 304 is meant to be illustrative only. For example, the user can begin the erasure process from within the cover 202 rather than on the side as shown in FIG. 3A, the user can have a non-linear movement across the cover 202 (e.g., a zigzag or an arc), and/or the like. The amount of the cover 202 removed along the path 304 is also meant to be illustrative and not limiting. For example, the width of the path erased by the cursor 302 (or other input device) can be configured based on the action being protected (e.g., for a less sever action, the width can be wider compared to a more severe action, where the width is smaller).

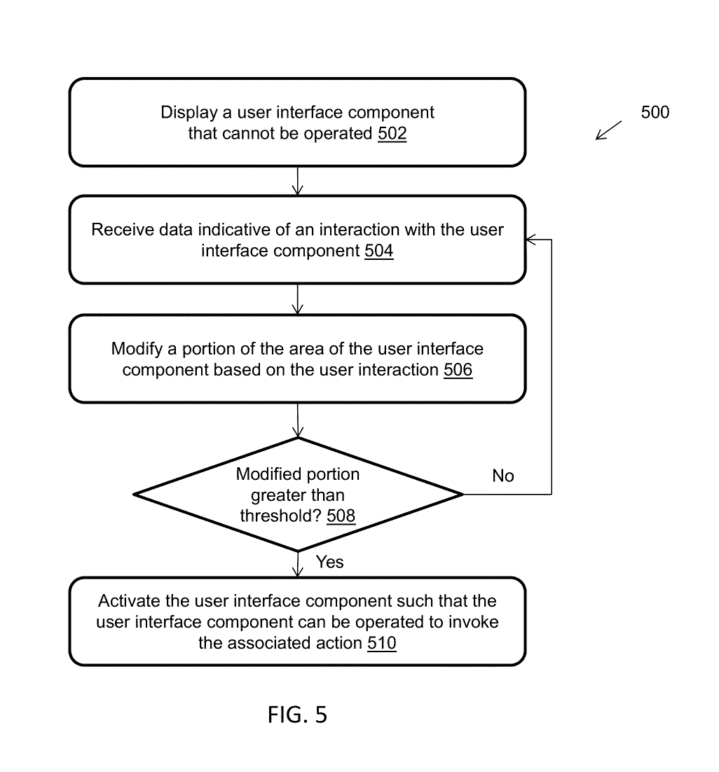

FIG. 3B is an exemplary diagram of the user interface 200 with a portion of the cover 202 to prevent accidental operation removed, according to some embodiments. Similar to FIG. 3A, the cursor 302 moves along the path represented by line 304. As the cursor 302 moves across the cover 202, the computing device (e.g., the web server 104 or the computing device 102) erases or removes that portion of the cover 202. The user interface 200, or other underlying components, are exposed to the user. Unlike the example in FIG. 3A, the example in FIG. 3B does not expose the button. Rather, the button only appears after the user has successfully taken actions to expose the button (e.g., as described with respect to FIG. 5 below).

In some embodiments, the cover 202 is a modified version of the user interface component. For example, a button can first be displayed as inactive and being grayed out, and as the user scratches away the grayed out button, the active button begins to shine through (or appears when a sufficient amount of the grayed out button is scratched away). In some embodiments, the cover 202 is not located over the user interface component, but instead is located separately from the user interface component. The user interface component can first be displayed as an inactive user interface component (e.g., such that even if a user attempts to invoke the user interface component, it does not result in any action), but after sufficient user interaction with the cover 202 the button can be re-displayed as an active user interface component (e.g., such that the user can invoke the user interface component). In some embodiments, the cover is a message keystrokes the user must press to invoke the component.

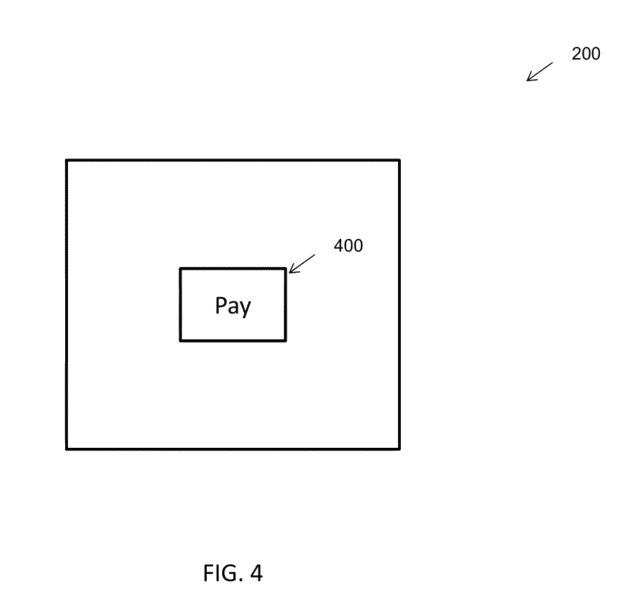

FIG. 4 is an exemplary diagram of a user interface component that is revealed after sufficient interaction with a cover (e.g., the cover 202 shown in FIG. 2), according to some embodiments. After sufficient user interaction with the cover 202 (e.g., as shown in FIG. 3A or 3B), the pay button 400 is revealed on the user interface 200. If the pay button 400 was simply displayed without requiring user interaction to activate the button 400, then a simple mouse click of the button could accidentally invoke an irrevocable action. By first displaying the cover 202 and requiring a sufficient amount of user interaction before displaying the button 400, a conscious effort must be made on the user's part to invoke the button 400. Unlike other preventative measures, such as “are you sure” dialogs that can be reflexively skipped over (e.g., by too quickly clicking or typing on an input device), the techniques disclosed herein avoid accidental reflexive responses and provide guaranteed time for reflection of the action by the user.

FIG. 5 is an exemplary diagram of a computerized method 500 for protecting a user interface component from accidental operation, according to some embodiments. At step 502, the computing device 102 displays a user interface component that cannot be operated by a user. At step 504 the computing device 102 receives data indicative of an interaction with the user interface component. At step 506, the computing device modifies a portion of the area of the user interface component based on the user interaction. At step 508, the computing device determines whether the modified portion is greater than a predetermined threshold. If the modified portion is greater than the predetermined threshold, the computerized method 500 proceeds to step 510 and the computing device activates the user interface component such that the user interface component can be operated to invoke the action associated with the component. If the modified portion is less than the predetermined threshold, the computerized method 500 proceeds back to step 504 and the computing device 102 does not activate the user interface component.

In some embodiments, the techniques can be implemented at the direction of the web server 104. For example, the computing device 102 can transmit the user interactions to the web server. The web server 104 can process the received data, and transmit data to the computing device 102. The user interface displayed in the computing device 102 can be updated in response to data transmitted from the web server 104. The computerized method 500 is described below using the computing device 102 for exemplary purposes only. One of skill in the art can appreciate that the computing device 102 and/or the web server 104, and/or other devices (not shown) can be used to implement the techniques described herein.

In some embodiments, the techniques described herein are implemented using, for example, a JavaScript program that is downloaded from the web server 104 to a web browser being executed by the computing device 102. In some embodiments, the cover 202 and the underlying user interface control can be implemented using a drawing canvas to display the graphics, and a drawing program to reflect interactions with the cover 202. For example, the JavaScript program can implement the user interface component as a control on a canvas that is initially transparent to the user. The cover 202 can be displayed as a set of pixels on the canvas. As interactions are received with the cover 202 (e.g., as explained with respect to FIG. 5 below), the drawing program can erase portions of the cover 202. Once enough of the cover 202 is erased, or “scratched away,” the web server 104 removes any remaining portions of the cover 202 to reveal the transparent user interface component. In some embodiments, if the user interface component is revealed during the scratching process (e.g., such as shown in FIG. 3A), a portion of the user interface component can be drawn where the cover 202 is removed to give the effect that the button is behind the cover 202. For example, using JavaScript the canvas area can be filled completely with a “fillRect” command to draw the cover, and the cleared areas can be drawn with the “clearRect” command to allow the background to be seen through the cover.

Referring to step 502, displaying the user interface component can include displaying an inactive user interface component, can include displaying a cover (e.g., the cover 202 shown in FIG. 2) in place of the user interface component, or can include displaying a message describing a set of keystrokes required to activate the user interface component. The displayed user interface component includes an area. The area can be, for example, the area of a user interface component, such as a button, a checkbox, a menu list, and/or other user interface components. In some examples, the area can be the area of a cover for the user interface component, which is representative of a button, an area around a checkbox and its associated text, and/or the like. The user interface component is associated with an action that can be invoked when the user interface component can be operated (e.g., to authorize a credit card purchase).

Referring to step 504, the computing device 102 receives data indicative of an interaction with the user interface component. The computing device 102 can receive data indicative of a mouse cursor interaction with the user interface component (e.g., a computer mouse), data generated by interaction of an input device with a touch pad or touch screen (e.g., a stylus, a user's finger, etc.), computer keyboard entries (e.g., one or more keyboard keystrokes), and/or any other type of input to the computing device 102. For example, referring to FIGS. 3A and 3B, the computing device 102 receives data indicative of the cursor 302 traveling across the cover 202 along the line 304 (e.g., with or without a mouse button pressed during movement along the line). As another example, the computing device 102 receives data indicative of a user's finger traveling across a display of the cover on a touchscreen device. As another example, the computing device can receive data indicative of a keystroke combination typed by a user (e.g., on a physical keyboard or on a touchscreen keyboard).

Referring to step 506, the computing device modifies a portion of the area of the user interface component based on the user interaction. In some embodiments, the computing device 102 modifies a cover that is displayed over, or in place of, the user interface component. For example, referring to FIG. 3B, the computing device 102 erases, or “scratches away,” the portion of the cover 202 along the path of the cursor 302 represented by line 304. In some embodiments, as shown in FIG. 3B, when the computing device 102 erases the portion of the cover 202, the computing device 102 displays a portion 300 of the underlying user interface component. In some embodiments, the computing device 102 modifies the user interface component itself. For example, the computing device 102 can display a greyed out (or inactive) version of the user interface component, and modify the portion of the greyed out user interface component that is manipulated by the user to display an active portion of the user interface component (e.g., under the path traveled by the cursor).

In some embodiments, the interaction is not with the user interface component itself. For example, if the computing device 102 is configured to receive a keystroke sequence to activate the user interface component, upon receipt of the proper keystroke sequence, the computing device 102 can modify the user interface component accordingly (e.g., by removing a cover and displaying the user interface component, or by displaying an active user interface component in place of an inactive user interface component).

Referring to step 508, the computing device determines whether the user interaction from step 504 is sufficient to activate the user interface component based on the threshold. For example, the threshold can be a required percentage of the user interface component surface area that must be erased (e.g., as shown in FIGS. 3A and 3B) before the computing device 102 will display an activated user interface component. For example, if the user removes a sufficient area of the cover, the computing device 102 enables the user interface component by removing the cover and displaying an active user interface component that can be operated to invoke the action associated with the component.

In some embodiments, the area of the cover 202 that needs to be scratched off before invoking the user interface component (e.g., as described with respect to step 208 of FIG. 5) can be configured for the particular application. For example, the area to be scratched off can be based on the operation associated with the user interface component. If the operation that only requires a small amount of protection (e.g., a button that authorizes submission of an online credit card purchase), then the system can be configured such that only a small amount of the cover 202 needs to be scratched off before revealing the user interface component (e.g., 5%, 10%, etc., and the width of the path erased can be sized accordingly). As another example, if the operation requires a large amount of protection (e.g., a button that initiates the firing of rocket boosters on a spaceship), then the system can be configured such that a large amount, or all, of the cover 202 needs to be scratched off before revealing the user interface component (e.g., 95% or 100% of the cover).

In some embodiments, the size of the cover 202 can be configured for the particular application. For example, the size of the cover 202 can be configured based on the action being protected. How large the cover 202 is can therefore affect the amount of user interaction required to scratch away the cover. In some embodiments, various combinations of features can be combined to achieve the desired functionality for the particular application (e.g., the size of the cover 202, the area of the cover 202 required to be scratched away before invoking the user interface component, etc.). For example, a button for sending an email could be a small cover with 50% clearance needed to reveal the send button. As another example, a button for firing rocket boosters on a spacecraft could be a 5 inch square with 95% clearance required (e.g., an early launch step may be “start revealing the fire button”).

If the user interaction is not sufficient, the user interface component remains inactive until the user's interaction is sufficient to prevent accidental invocation of the user interface component. The computing device 102 can receive a new percentage for a user interface component and update the threshold. For example, if a system administrator determines that a particular button does not need to be protected as much as it was originally configured (e.g., to improve a user experience), the system administrator can reconfigure the user interface component accordingly.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A computerized method for protecting a user interface component from accidental operation, the method comprising:
displaying, by a computing device, a user interface component that cannot be operated, wherein the user interface component comprises:
an area; and
the user interface component is associated with an action that can be invoked when the user interface component can be operated;
receiving, by the computing device, data indicative of an interaction with the user interface component;
modifying, by the computing device, a portion of the area of the user interface component based on the user interaction;
determining, by the computing device, whether the modified portion is greater than a predetermined threshold; and
if the modified portion is greater than the predetermined threshold, activating, by the computing device, the user interface component such that the user interface component can be operated to invoke the associated action.

2. The method of claim 1, wherein if the modified portion is less than the predetermined threshold, the computing device does not activate the user interface component.

3. The method of claim 1, wherein displaying the user interface component comprises displaying a cover over the user interface component such that the user interface component is not displayed since the user interface component is behind the cover.

4. The method of claim 3, wherein modifying the portion of the area of the user interface component based on the user interaction comprises removing a displayed portion of the cover based on the received data to reveal a hidden portion of the user interface component below the removed displayed portion.

5. The method of claim 4, wherein the received data comprises data indicative of a portion of the cover traveled over by a mouse cursor, an input device on a touch pad, or any combination thereof.

6. The method of claim 3, wherein the user interface component is a button, and wherein:
displaying the cover comprises displaying a representation of a scratch cover in place of the button; and
wherein modifying a portion of the area of the user interface component based on the user interaction comprises removing a displayed portion of the scratch cover based on the received data and displaying a first portion of the user interface component as if the user interface component were behind the scratch cover.

7. The method of claim 3, wherein the cover comprises a message indicative of the user interface component and a set of one or more steps that can be taken to activate the user interface component.

8. The method of claim 1, wherein determining whether the modified portion is greater than the predetermined threshold comprises:
storing a threshold percentage of the area of the user interface component that must be modified to activate the user interface component; and
determining the modified portion of the area of the user interface component compared to the area of the user interface component is greater than the threshold percentage.

9. The method of claim 8, further comprising:
receiving data indicative of a new threshold percentage; and
replacing the threshold percentage with the new threshold percentage.

10. A computing device comprising:
a database; and
a processor in communication with the database, and configured to run a module stored in memory that is configured to cause the processor to:
display a user interface component that cannot be operated, wherein the user interface component comprises:
an area; and
the user interface component is associated with an action that can be invoked when the user interface component can be operated;
receive data indicative of an interaction with the user interface component;
modify a portion of the area of the user interface component based on the user interaction;
determine whether the modified portion is greater than a predetermined threshold; and
if the modified portion is greater than the predetermined threshold, activate the user interface component such that the user interface component can be operated to invoke the associated action.

11. The computing device of claim 10, wherein if the modified portion is less than the predetermined threshold, the computing device does not activate the user interface component.

12. The computing device of claim 10, wherein displaying the user interface component comprises displaying a cover over the user interface component such that the user interface component is not displayed since the user interface component is behind the cover.

13. The computing device of claim 12, wherein modifying the portion of the area of the user interface component based on the user interaction comprises removing a displayed portion of the cover based on the received data to reveal a hidden portion of the user interface component below the removed displayed portion.

14. The computing device of claim 13, wherein the received data comprises data indicative of a portion of the cover traveled over by a mouse cursor, an input device on a touch pad, or any combination thereof.

15. The computing device of claim 12, wherein the user interface component is a button, and wherein:
displaying the cover comprises displaying a representation of a scratch cover in place of the button; and
wherein modifying a portion of the area of the user interface component based on the user interaction comprises removing a displayed portion of the scratch cover based on the received data and displaying a first portion of the user interface component as if the user interface component were behind the scratch cover.

16. The computing device of claim 12, wherein the cover comprises a message indicative of the user interface component and a set of one or more steps that can be taken to activate the user interface component.

17. The computing device of claim 10, wherein determining whether the modified portion is greater than the predetermined threshold comprises:
storing a threshold percentage of the area of the user interface component that must be modified to activate the user interface component; and
determining the modified portion of the area of the user interface component compared to the area of the user interface component is greater than the threshold percentage.

18. The computing device of claim 17, wherein the module stored in memory is further configured to cause the processor to:
receive data indicative of a new threshold percentage; and
replace the threshold percentage with the new threshold percentage.

19. A non-transitory computer readable medium having executable instructions operable to cause an apparatus to:
display a user interface component that cannot be operated, wherein the user interface component comprises:
an area; and
the user interface component is associated with an action that can be invoked when the user interface component can be operated;
receive data indicative of an interaction with the user interface component;
modify a portion of the area of the user interface component based on the user interaction;
determine whether the modified portion is greater than a predetermined threshold; and
if the modified portion is greater than the predetermined threshold, activate the user interface component such that the user interface component can be operated to invoke the associated action.
